(19) United States
(12) Patent Application Publication
(10) Pub. No.: US 2026/0195709 A1
(43) Pub. Date: Jul. 9, 2026

(54) APPARATUS, METHOD AND RECORDING MEDIUM FOR MANAGING INVENTORY

(71) Applicant: Coupang Corp., Seoul (KR)

(72) Inventor: Amit TIKOO, Seoul (KR)

(21) Appl. No.: 19/076,268

(22) Filed: Mar. 11, 2025

(30) Foreign Application Priority Data
Nov. 11, 2024 (KR) 10-2024-0158882

(51) Int. Cl. G06Q 10/087; G06Q 10/0875

(52) U.S. Cl. CPC G06Q 10/08772; G06Q 10/0875

(57) ABSTRACT

An apparatus includes at least one processor and at least one memory storing instructions that, based on being executed by the at least one processor, perform operations. The operations includes: receiving, from a user terminal, a request for return of inventory information of at least one item stored at a location at a first time point, in response to receiving the request for the inventory information, obtaining event information including pieces of information each corresponding to an event that caused a change in inventory of items associated with the location before the first time point, generating the inventory information of the at least one item stored at the location at the first time point based on the event information, and transmitting the inventory information to the user terminal.

### CROSS-REFERENCE TO RELATED APPLICATION(S)

This application is based upon and claims the benefit of priority from Korean Patent Application No. 2024-0158882, filed on Nov. 11, 2024, the entire contents of which are incorporated herein by reference.

### TECHNICAL FIELD

The present disclosure relates to a technology for item inventory management.

### BACKGROUND

Consumers may purchase items online through an e-commerce service. To provide the e-commerce service, a service provider may operate a logistics center. The service provider may manage the processing and delivery of item orders at the logistics center. As the types and number of items handled in the e-commerce service increase, the service provider needs to manage the item inventory more accurately.

### SUMMARY

The present disclosure describes generating information about an event that caused a change in inventory of an item.

The present disclosure further describes generating item inventory information based on information about an event.

The present disclosure further describes managing information about an event based on snapshot information.

The technical tasks of the present disclosure are not limited to the above-mentioned technical tasks, and other technical tasks not described will be clearly understood by those skilled in the art from the description below.

According to one aspect of the subject matter described in this application, an apparatus includes at least one processor and at least one memory storing instructions that, based on being executed by the at least one processor, perform operations. The operations include receiving, from a user terminal, a request for inventory information of at least one item stored at a location at a first time point, in response to receiving the request for the inventory information, obtaining event information including pieces of information each corresponding to an event that caused a change in inventory of items associated with the location before the first time point, generating the inventory information of the at least one item stored at the location at the first time point based on the event information, and transmitting the inventory information to the user terminal.

Implementations according to this aspect can include one or more of the following features. For example, the operations can further include generating and storing each piece of information corresponding to the event based on the change occurring in the inventory of the items associated with the location.

In some implementations, each piece of information corresponding to the event can include at least one of (i) information indicating the change in the inventory of the items associated with the location, (ii) information used to identify the items associated with the location, or (iii) information used to identify the location.

In some implementations, the operations can further include assigning, as snapshot information, a piece of information corresponding to an event that is stored at a predetermined sequence number among the pieces of information, where the snapshot information can include identification information used to identify the piece of information corresponding to the event that is stored at the predetermined sequence number.

In some examples, the snapshot information further can include information indicating inventory of each of the at least one item associated with the location at a time of generating the snapshot information.

In some examples, the operations can further include determining the predetermined sequence number based on a number of the pieces of information.

In some implementations, the operations can further include storing the snapshot information in a storage space that is different from a storage space for pieces of information each corresponding to an event to which the identification information is not assigned.

In some examples, the operations can further include identifying target snapshot information among the snapshot information in response to the request for the inventory information, and generating the inventory information based on the target snapshot information and pieces of information each corresponding to an event stored after the target snapshot information was stored.

In some examples, the request for the inventory information can include information indicating a target item among the at least one item, where the operations can further include identifying pieces of snapshot information including the information indicating the target item among the snapshot information; identifying, as the target snapshot information, one of the pieces of snapshot information to which the identification information is assigned at a second time point closest to the first time point, among the pieces of snapshot information including the information indicating the target item; and generating the inventory information based on (i) the target snapshot information and (ii) a piece of information that can include the information indicating the target item among a subset of the event information that is stored between the second time point and the first time point.

In some implementations, the request for the inventory information can include information indicating a target state among states of the at least one item, where the operations can further include identifying a piece of information that can include the information indicating the target state among the pieces of information included in the event information, and generating the inventory information based on the piece of information including the information indicating the target state.

According to another aspect, a method includes: receiving, from a user terminal, a request for inventory information of at least one item stored at a location at a first time point; in response to receiving the request for the inventory information, obtaining event information including pieces of information each corresponding to an event that caused a change in inventory of items associated with the location before the first time point; generating the inventory information of the at least one item stored at the location at the first time point based on the event information; and transmitting the inventory information to the user terminal.

Implementations according to this aspect can include one or more of the following features. For example, the method can further include generating and storing each piece of information corresponding to the event based on the change occurring in the inventory of the items associated with the location.

In some implementations, each piece of information corresponding to the event can include at least one of (i) information indicating the change in the inventory of items associated with the location, (ii) information used to identify the items associated with the location, or (iii) information used to identify the location.

In some implementations, the method can further include assigning, as snapshot information, a piece of information corresponding to an event that is stored at a predetermined sequence number among the pieces of information, where the snapshot information can include identification information used to identify the piece of information corresponding to the event that is stored at the predetermined sequence number.

In some examples, the method can further include determining the predetermined sequence number based on a number of the pieces of information.

In some implementations generating the inventory information of the at least one item stored at the location at the first time point can include: identifying target snapshot information among the snapshot information in response to the request for the inventory information, and generating the inventory information based on the target snapshot information and pieces of information each corresponding to an event that are stored after the target snapshot information was stored.

In some implementations, the request for the inventory information can include information indicating a target item among the at least one item, where identifying the target snapshot information among the snapshot information can include: identifying pieces of snapshot information including the information indicating the target item among the snapshot information; and identifying, as the target snapshot information, one of the species of snapshot information to which the identification information is assigned at a second time point closest to the first time point, among the pieces of snapshot information including the information indicating the target item. Generating the inventory information based on the target snapshot information and the pieces of information that are stored after the target snapshot information was stored can further include: obtaining first inventory information of the target item at the second time point, identifying, based on the pieces of information that are stored between the second time point and the first time point, at least one piece of information each corresponding to an event of the target item, and generating the inventory information based on the first inventory information and the at least one piece of information corresponding to the event of the target item.

According to another aspect, a non-transitory computer-readable recording medium storing instructions, wherein execution of the instructions causes at least one processor to perform operations. The operations include receiving, from a user terminal, a request for inventory information of at least one item stored at a location at a first time point; in response to receiving the request for the inventory information, obtaining event information including pieces of information each corresponding to an event that caused a change in inventory of items associated with the location before the first time point; generating the inventory information of the at least one item stored at the location at the first time point based on the event information; and transmitting the inventory information to the user terminal.

According to at least an implementation of the present disclosure, information about an event that caused a change in inventory of an item can be generated.

According to at least an implementation of the present disclosure, inventory information of an item can be generated based on information about an event.

According to at least an implementation of the present disclosure, information about an event can be managed based on snapshot information.

Effects of the technical idea of the present disclosure are not limited to those mentioned above, and other effects not mentioned will be clearly understood by those skilled in the art from the description of the present disclosure.

### BRIEF DESCRIPTION OF DRAWINGS

FIG. 1 illustrates an example environment in which an example of an apparatus is applied.

FIG. 2 is a block diagram of an example of the apparatus.

FIG. 3 illustrates a flowchart of example operations.

FIG. 4 illustrates an example of a process for producing pieces of information each corresponding to an event.

FIG. 5 illustrates an example of event information.

FIG. 6 illustrates an example of inventory information of an item associated with a location.

FIG. 7 illustrates an example of a process for producing inventory information of a target item.

FIG. 8 illustrates an example of a process for producing inventory information of a target state.

### DETAILED DESCRIPTION

Various implementations described in the present disclosure are exemplified for the purpose of clearly explaining the technical idea of the present disclosure, and are not intended to limit the present disclosure to specific implementations. The technical idea of the present disclosure includes various modifications, equivalents, and alternatives of each implementation described in the present disclosure, and implementations selectively combined from all or a part of each implementation. In addition, the scope of the technical idea of the present disclosure is not limited to various implementations presented below or detailed description thereof.

All terms used in the present disclosure, including technical or scientific terms, have meanings that are generally understood by those skilled in the art to which the present disclosure pertains, unless otherwise defined.

Expressions used in the present disclosure, such as “include,” “may include,” “provided with,” “may be provided with,” “have,” “may have,” etc., imply that target features (e.g., a function, an operation, or an element) are present, and do not exclude the presence of other additional features. That is, such expressions should be understood as open-ended terms connoting the possibility of inclusion of other implementations.

A singular expression used in the present disclosure can include meanings of plurality, unless otherwise mentioned in the context, and this also applies to a singular expression recited in the claims.

The expression such as “a first,” “a second,” “first,” or “second” used in the present disclosure is used to distinguish one object from another object in referring to a plurality of homogeneous objects, unless the context dictates otherwise, and does not limit the order or the importance between the objects.

Expressions, such as “A, B, and C,” “A, B, or C,” “A, B, and/or C,” “at least one of A, B, and C,” “at least one of A, B, or C,” “at least one of A, B, and/or C,” etc. used in the present disclosure, can imply each listed item or all possible combinations of listed items. For example, “at least one of A or B” can refer to all of (1) at least one A, (2) at least one B, and (3) at least one A and at least one B.

The expression “based on” used in the present disclosure is used to describe one or more factors that influence a decision, an action of judgment, or an operation described in a phrase or a sentence including this expression, and this expression does not exclude an additional factor influencing the decision, the action of judgment, or the operation.

The expression “configured to” used in the present disclosure can imply “designed to,” “having the capacity to,” “adapted to,” “made to,” “capable of,” etc. according to the context. This expression is not limited to implying “specifically designed in hardware.” For example, a processor configured to perform a specific operation can imply a generic-purpose processor capable of performing the specific operation by executing software, or can imply a special-purpose computer structured through programming to perform the specific operation.

Hereinafter, various implementations of the present disclosure will be described with reference to the accompanying drawings. In the accompanying drawings and the description of the drawings, identical or substantially equivalent elements can be given the same reference numerals. Furthermore, in the following description of various implementations, redundant descriptions of the same or corresponding elements can be omitted, but this does not imply that the elements are not included in the implementations.

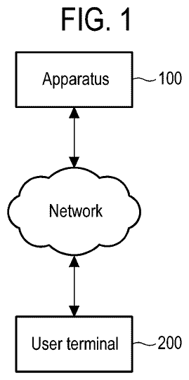

FIG. 1 illustrates an example environment in which an apparatus is applied. For example, an apparatus 100 and a user terminal 200 can be connected to each other via a network to communicate with each other. The apparatus 100 can be a server apparatus that processes information about items handled through an e-commerce service. In other words, the apparatus 100 can be an apparatus operated under the management of an operating entity of an e-commerce service. In some examples, the e-commerce service provided by the apparatus 100 can be any service that responds to a purchase request from a consumer, sells an item corresponding to the purchase request, and manages information related thereto.

In some implementations, the apparatus 100 can be a server apparatus for managing the inventory of items sold in an e-commerce service. The apparatus 100 can be a server apparatus for managing at least one of stocking in, stocking out, moving, or discarding items. For example, the apparatus 100 can be a server apparatus for managing the inventory of items, sold in the e-commerce service, which fluctuates as the items are stocked in at a location. The apparatus 100 can be a server apparatus that manages the inventory of items, sold in the e-commerce service, which fluctuates as the items are stocked out from a location to a consumer. The apparatus 100 can be a server apparatus that manages the inventory of items, sold in the e-commerce service, which fluctuates as the items are moved from one location to another location. The apparatus 100 can be a server apparatus that manages the inventory of items, sold in the e-commerce service, which fluctuates as the items are discarded from a location for various reasons. In some implementations, a location may not necessarily be defined as a specific logistics center, but containers within a logistics center, or areas within the logistics center that are separated by predetermined criteria, can be defined as locations, and a fulfillment center, a hub, and the like can be defined as locations.

The apparatus 100 can be a server apparatus for managing information about an event which caused a change in inventory of items sold in the e-commerce service. The apparatus 100 can generate pieces of information each corresponding to an event that caused a change in inventory of items when a change occurs in the inventory of an item associated with a location. In some implementations, the apparatus 100 can generate pieces of information each corresponding to an event indicating a change in inventory that occurs as an item sold in the e-commerce service is stocked in a location, stocked out from a location, moved from one location to another location, or discarded at a location. The pieces of information each corresponding to an event generated by the apparatus 100 can be stored in a storage area included with the apparatus 100 or in a storage area outside the apparatus 100. The apparatus 100 can generate pieces of information each corresponding to an event based on the order in which changes occur in inventory of items associated with a location. In some implementations, the apparatus 100 can assign a piece of information corresponding to an event stored at a predetermined sequence number as snapshot information. The apparatus 100 can assign identification information used to identify the piece of information corresponding to an event stored at the predetermined sequence number during the process of producing the piece of information corresponding to an event. A snapshot can be defined as a function of storing information at a specific time point. The apparatus 100 can assign the piece of information corresponding to an event stored at the predetermined sequence number as snapshot information, and update inventory information of at least one item based on the snapshot information. In some implementations, the snapshot information can further include the piece of information corresponding to an event, information about a time point of generating the snapshot information, and information indicating the inventory of each of at least one item associated with a corresponding location at the time of generating the snapshot information.

The apparatus 100 can be a server apparatus that manages event information regarding inventory changes of at least one item associated with a location for each location. The apparatus 100 can be a server apparatus that manages event information that includes pieces of information each corresponding to an event regarding at least one item that occurred at each location. The apparatus 100 can generate event information that includes pieces of information each corresponding to an event that caused a change in inventory of an item associated with a location.

The user terminal 200 can be a terminal for managing inventory of items at a location. The user terminal 200 can be assigned to each location and can be for managing changes in inventory of items occurring at the assigned location. In some implementations, a user can use the user terminal 200 to input the fact that at least one item at a location has been stocked in, stocked out, moved, or discarded. In another implementation, the user terminal 200 may not be a terminal assigned to each location, but can be any terminal for requesting inventory information of an item associated with each of at least one location. The user terminal 200 can be implemented as a terminal capable of performing transmission and reception with the apparatus 100 over a network. For example, the user terminal 200 can be implemented as a computer, a laptop, a portable communication terminal (such as a smartphone), a portable multi median apparatus, or the like. However, the type of user terminal 200 is not limited thereto, and the user terminal 200 can be any apparatus that includes an input/output interface capable of outputting information and communicating with the apparatus 100 or other apparatus or modules over a network.

The user terminal 200 can provide information obtained from the apparatus 100 to the user, obtain an input from the user, or transmit the obtained input to the apparatus 100. The input obtained from the user can include various types of inputs, such as clicks using a mouse, touches using a touch pad or touch screen, voice recognition, a barcode input, a quick response (QR) input, or other electronic inputs. In some implementations, the user terminal 200 can input information about an item being stocked in an assigned location, input information about an item being stocked out from an assigned location, input information about an item being moved from an assigned location to another location, or input information about an item being discarded at an assigned location. In another implementation, the user terminal 200 may not be assigned to a location, and can obtain any user input for requesting inventory information of items associated with the location. The information about the item that has been input via the user terminal 200 can be transmitted to the apparatus 100 and used to generate a record of an event. The user terminal 200 can be connected to the apparatus 100 or other apparatuses, terminals, or modules through a network and communicate with each other. For example, the apparatus 100 and the user terminal 200 can be connected and communicate with each other via a network that provides an access path for transmitting and receiving packet data. The network can be implemented as any kind of wired or wireless network, such as a local area network (LAN), a wide area network (WAN), a mobile radio communication network, a wireless broadband Internet (WiBro), or the like.

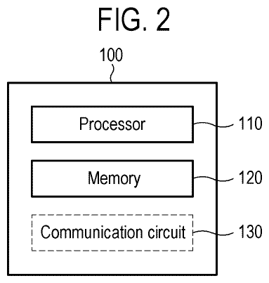

FIG. 2 is a block diagram of an example of an apparatus. The apparatus 100 can include at least one processor 110 and/or at least one memory 120 as components. Additionally, in some implementations, at least one of the components of the apparatus 100 can be omitted, or other components can be added to the apparatus 100. In some implementations, additionally or alternatively, some of the components can be integrated and implemented, or can be implemented as a single or multiple elements. In the present disclosure, the at least one processor 110 can be referred to as a processor 110. The term “processor 110” can refer to a set of one or more processors, unless the context clearly indicates otherwise. In the present disclosure, the at least one memory 120 can be referred to as a memory 120. The term “memory 120” can refer to a set of one or more memories, unless the context clearly indicates otherwise. In some implementations, at least some of components inside/outside the apparatus 100 can be connected to each other via a bus, General-Purpose Input/Output (GPIO), Serial Peripheral Interface (SPI), or Mobile Industry Processor Interface (MIPI) to transmit and receive information (data, signals, etc.).

In some implementations, the apparatus 100 can further include a communication circuit 130. The apparatus 100 can communicate with a user terminal 200 via the communication circuit 130. That is, the communication circuit 130 can be configured to perform wireless or wired communication between the apparatus 100 and the user terminal 200. For example, the communication circuit 130 can perform wireless communication according to schemes such as enhanced Mobile Broadband (eMBB), Ultra Reliable Low-Latency Communications (URLLC), Massive Machine Type Communications (MMTC), Long-Term Evolution (LTE), LTE Advance (LTE-A), New Radio (NR), Universal Mobile Telecommunications System (UMTS), Global System for Mobile communications (GSM), Code Division Multiple Access (CDMA), Wideband CDMA (WCDMA), Wireless Broadband (WiBro), Wireless Fidelity (WiFi), Bluetooth, Near-Field Communication (NFC), Global Positioning System (GPS), or Global Navigation Satellite System (GNSS). For example, the communication circuit 130 can perform wired communication according to schemes such as Universal Serial Bus (USB), High-Definition Multimedia Interface (HDMI), Recommended Standard-232 (RS-232), or Plain Old Telephone Service (POTS). In some implementations, the apparatus 100 can be implemented to be integrated with another apparatus. In this case, the communication circuit 130 can function as a connection circuit or interface for connecting the apparatus 100 to the other apparatus.

The processor 110 can execute software (e.g., commands, programs, etc.) to control at least one component of the apparatus 100 connected to the processor 110. The processor 110 can also perform various operations, such as calculation, processing, data production, processing, etc. related to the present disclosure. Further, the processor 110 can load data, etc. from or store data, etc. in the memory 120. Furthermore, the processor 110 can transmit and receive various types of information to and from the user terminal 200 via the communication circuit 130. In some implementations, the processor 110 can control the communication circuit 130 to transmit various types of information to the user terminal 200 in various forms.

The memory 120 can store various types of information (data). The information stored in the memory 120 can be information that is acquired, processed, or used by at least one component of the apparatus 100, and can include software (e.g., instructions, programs, etc.). The memory 120 can include a volatile and/or non-volatile memory. In the present disclosure, commands or programs are software stored in the memory 120, and can include an operating system for controlling resources of the apparatus 100, an application, and/or middleware that provides various functions to the application to allow the application to utilize resources of the apparatus 100. In some implementations, the memory 120 can store instructions that, when executed by the processor 110, cause the processor 110 to perform calculation. The memory 120 can store at least a portion of information received from the user terminal 200 via the communication circuit 130 and/or information transmitted to the user terminal 200 via the communication circuit 130. For example, the memory 120 can store information about an item obtained from the user terminal 200, pieces of information each corresponding to an event generated by the apparatus 100, and the like, but is not limited thereto.

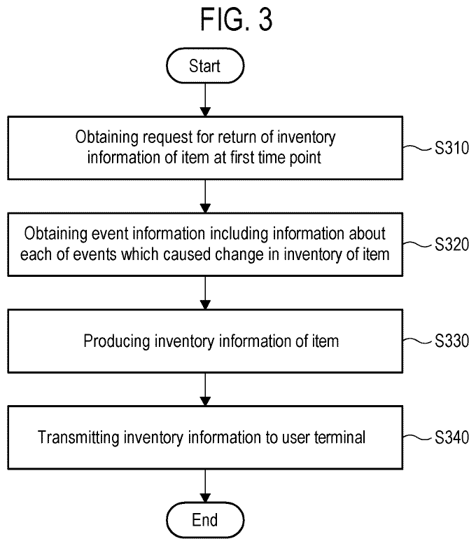

FIG. 3 illustrates a flowchart of example operations. A method performed by the apparatus 100 can include operations S310 to S340. It can be understood that operations S310 to S340, described below, are performed by the apparatus 100 that includes at least one processor 110 and at least one memory 120, which stores instructions to be executed by the at least one processor 110.

In operation S310, the processor 110 of the apparatus 100 can obtain a request for return of inventory information of an item at a first time point. The processor 110 of the apparatus 100 can receive, from a user terminal 200, a request for return of inventory information of at least one item stored at a location. In some implementations, the inventory information can include, but is not limited to, information indicating a quantity of the at least one item stored at the location. In some implementations, the request for return of inventory information can include at least one of information indicating a target item which is the target of the request or information indicating a target state (e.g., stocked in a location, stocked out from a location, moved from a location, and discarded at a location).

In operation S320, the processor 110 of the apparatus 100 can obtain event information including pieces of information each corresponding to an event that caused a change in inventory of the item. In some implementations, the processor 110 of the apparatus 100 can obtain event information that includes information about each of events that caused a change in the inventory of an item associated with a location before the first time point. The pieces of information each corresponding to an event can include at least one among information indicating a change in inventory of an item associated with the location, information used to identify the item associated with the location, and information used to identify the location.

In operation S330, the processor 110 of the apparatus 100 can generate inventory information of an item. The processor 110 of the apparatus 100 can identify target snapshot information among stored snapshot information, and generate inventory information of the item based on the target snapshot information and pieces of information each corresponding to an event stored after the target snapshot information was stored. For example, when the request for return of inventory information includes information indicating a target item, the apparatus 100 can identify, as the target snapshot information, snapshot information to which identification information is assigned at a second time point that is closest to the first time point among snapshot information that includes the information indicating the target item. The processor 110 of the apparatus 100 can generate inventory information based on the target snapshot information and pieces of information each corresponding to an event including the information indicating the target item, among event information stored between the second time point and the first time point.

In operation S340, the processor 110 of the apparatus 100 can transmit the inventory information to the user terminal 200. In some implementations, the inventory information can be displayed on the user terminal 200 and can be used to display inventory information for at least one of the target item or the target state. For example, the inventory information can be used by the user terminal 200 to display a quantity of inventory of a target item at a location. In another example, the inventory information can be used by the user terminal 200 to display at least one item that is stocked in a location.

In the flowchart of the present disclosure, the operations of the method or algorithm have been described in a sequential order, but the operations can be performed in any order that can be arbitrarily combined in accordance with the present disclosure, in addition to being performed sequentially. The description of the flowchart in the present disclosure does not exclude making changes or modifications to the method or algorithm and does not imply that any operation is essential or preferable. In some implementations, at least some of the operations can be performed in parallel, iteratively, or heuristically. In another implementation, at least some of the operations can be omitted, or other operations can be added.

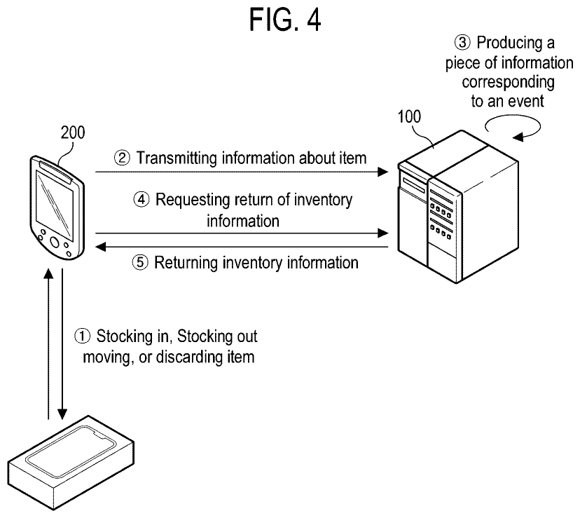

FIG. 4 illustrates an example of a process for producing pieces of information each corresponding to event information. A user terminal 200 can transmit information about an item to an apparatus 100 in response to a change in inventory of an item associated with a location managed by the user terminal 200. In some implementations, the change in inventory of the item associated with the location can be caused by an event in which the item is stocked in the location, stocked out from the location, moved to or from another location, or discarded at the location.

As inventory of an item is changed by stocking in, stocking out, moving, or discarding the item, the user terminal 200 can input the change in inventory of the item. In some implementations, the user terminal 200 can input a barcode, a QR code, or the like attached to the item to input the fact that the change in the inventory of the item has occurred.

The user terminal 200 can transmit, to the apparatus 100, information about the item for which the inventory change was input. The user terminal 200 can input the change in inventory of the item and generate information about the item. In some implementations, the information about the item can include at least one among information about a time point in which the change in inventory of the item was input, information used to identify the item, information about a location to which the user terminal 200 is assigned, and information about a worker.

The information about the item can be automatically transmitted to the apparatus 100 when the inventory change of the item is input into the user terminal 200, or can be transmitted to the apparatus 100 by a worker managing the user terminal 200.

The apparatus 100 can generate pieces of information each corresponding to an event based on the information about the item obtained from the user terminal 200. The apparatus 100 can sequentially generate pieces of information each corresponding to an event based on the order in which the information about the items is obtained from the user terminal 200. In some implementations, the pieces of information each corresponding to an event can include at least one among information indicating a change in inventory of an item associated with a location, information used to identify the item associated with the location, and information used to identify the location. The apparatus 100 can easily manage items not only by simply managing the quantity of inventory of an item but also by producing and managing information about what events caused a change in inventory of items at a location, i.e., pieces of information each corresponding to an event recording an event. However, as the number of items and types of items associated with a location increase, storing all of the pieces of information each corresponding to an event can be performed with a larger storage area.

In generating the pieces of information each corresponding to an event, the apparatus 100 can assign a piece of information corresponding to an event that is stored at a predetermined sequence number as snapshot information. A snapshot can be defined as a function of storing information at a specific time point. In other words, the apparatus 100 can assign a piece of information corresponding to an event stored at the predetermined sequence number as snapshot information, and can manage, based on the snapshot information, pieces of information each corresponding to an event information about an event in which a change in inventory of an item occurred. In some implementations, the apparatus 100 can manage the snapshot information based on a clone snapshot (split mirror) method in which the piece of information corresponding to an event that is stored at the predetermined sequence number is copied as it is and stored as snapshot information. The apparatus 100 can manage the snapshot information based on a continuous data protection method that allocates snapshot information each time pieces of information each corresponding to an event is stored. The apparatus 100 can manage the snapshot information based on a Copy-on-Write (COW) method in which, when pieces of information each corresponding to an event is stored (a write operation), a previously stored piece of information corresponding to an event is assigned as snapshot information. In other words, the apparatus 100 can efficiently perform data recovery up to the time point when the most recent snapshot information was stored, based on the most recently stored snapshot information.

As the apparatus 100 generates the snapshot information, the apparatus 100 can generate the snapshot information that includes inventory information of each of at least one item associated with a location at the time point at which the snapshot information is generated. Each time the apparatus 100 generates snapshot information, the apparatus 100 can calculate the inventory of each of the at least one item associated with the location and generate the snapshot information including inventory information indicating the inventory of each of the at least one item. In generating second snapshot information, the apparatus 100 can calculate the inventory of each of at least one item based on first snapshot information, and based on information about at least one event stored after the generation of the first snapshot information, can calculate the inventory of each of the at least one item associated with a location. In some examples, the first snapshot information can be one of pieces of snapshot information generated before the second snapshot information is generated. In some implementations, the first snapshot information can be the most recently generated snapshot information among the snapshot information generated before the second snapshot information is generated, but is not limited thereto.

The apparatus 100 can determine a piece of information corresponding to an event to be assigned as snapshot information, e.g., the predetermined sequence number, based on a variety of methods. The apparatus 100 can determine the predetermined sequence number based on the number of stored pieces of information each corresponding to an event. In some implementations, the apparatus 100 can assign snapshot information whenever the number of pieces of information each corresponding to an event being stored is a multiple of N, where N is a natural number. In this case, the predetermined sequence number can be a multiple of N. For example, when Nis 1,000, the apparatus 100 can assign a 1,000th stored piece of information corresponding to an event as snapshot information, and can assign a 2,000th stored piece of information corresponding to an event as snapshot information. In some implementations, as the number of stored pieces of information each corresponding to an event increases, the apparatus 100 can increase the frequency of assigning snapshot information. For example, the apparatus 100 can assign a piece of information corresponding to an event in the order of multiples of 1,000 as snapshot information until 10,000 pieces of information each corresponding to an event are stored, and then, when the number of pieces of information each corresponding to an event exceeds 10,000, assign, as snapshot information, a piece of information corresponding to an event stored in the order of multiples of 500, such as a 10,500th, 11,000th, or 11,500th stored piece of information corresponding to an event. In some implementations, the apparatus 100 can adjust the interval of the order of assigning snapshot information as the number of stored pieces of information each corresponding to an event increases, such as by assigning 5,000th, 9,000th, 12,000th, 14,000th, 15,000th, and 15,500th stored pieces of information corresponding to an event as snapshot information.

The apparatus 100 can store the generated pieces of information each corresponding to an event. The apparatus 100 can store the pieces of information each corresponding to an event in a database or a memory 120 included in the apparatus 100. The apparatus 100 can store the pieces of information each corresponding to an event on an apparatus (a server, etc.) outside the apparatus 100. In some implementations, the apparatus 100 can be configured to store a piece of information corresponding to an event that is assigned as snapshot information among the pieces of information each corresponding to an event in a storage area different from that of pieces of information each corresponding to an event that is not assigned as snapshot information. In this case, the apparatus 100 can manage the snapshot information in a decentralized manner to more safely recover pieces of information each corresponding to an event.

The user terminal 200 can transmit, to the apparatus 100, a request for return of inventory information at a first time point. The user terminal 200 can transmit, to the apparatus 100, a request for return of inventory information that requests an inquiry about the quantity of inventory of a target item at the first time point among at least one item associated with a location. In some implementations, the request for return of inventory information can include information indicating the target item. The user terminal 200 can transmit, to the apparatus 100, a request for return of inventory information that requests pieces of information each corresponding to an event of a target state of the at least one item associated with the location. In some implementations, the request for return of inventory information can include information indicating the target state. The user terminal 200 can transmit, to the apparatus 100, a request for return of inventory information regarding a target time interval. In some implementations, the request for return of inventory information can include information about the start time point and end time point of the target time interval.

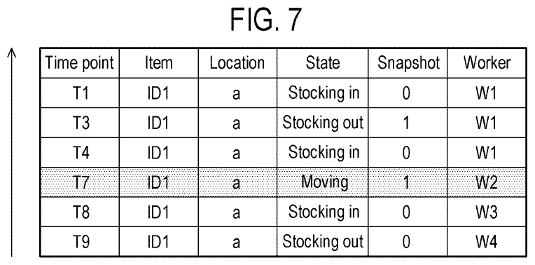

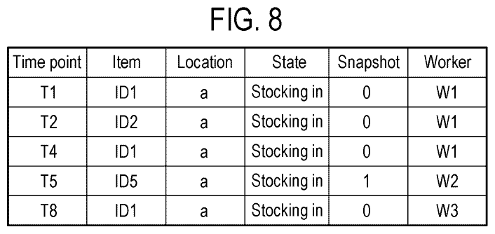

In response to the return of inventory information obtained from the user terminal 200, the apparatus 100 can generate inventory information. The apparatus 100 can generate the inventory information based on event information stored before the first time point. The process of generating the inventory information by the apparatus 100 will be described later with reference to FIGS. 7 and 8.

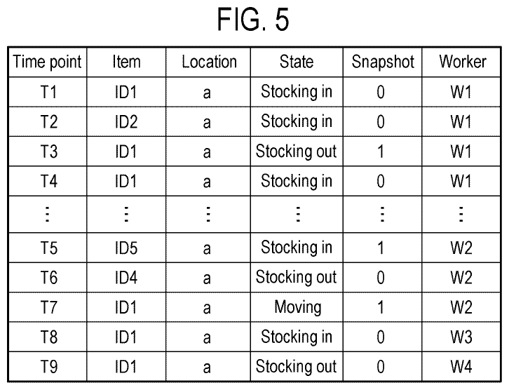

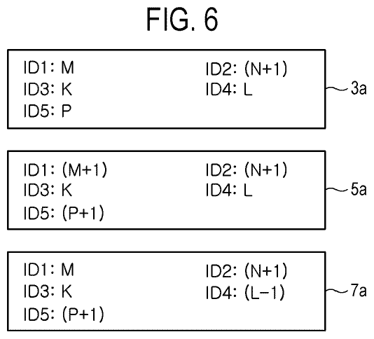

FIG. 5 illustrates an example of event information. FIG. 6 illustrates an example of inventory information of an item associated with a location. The event information can include at least one piece of information corresponding to an event. Each piece of the information corresponding to an event can include at least one among information indicating a change in inventory of an item associated with a location, information used to identify the item associated with the location, or information used to identify the location. In some implementations, the pieces of information each corresponding to an event can further include identification information to identify that the piece of information corresponding to an event is snapshot information, and information about a worker.

Hereinafter, for ease of description, the description is made assuming that changes occur in the inventory of items associated with location a. However, the present disclosure is not limited thereto, and the apparatus 100 can generate event records regarding at least one location other than location a. In some implementations, the inventory of a first item ID1 associated with location a before time point T1 can be M, the inventory of a second item ID2 can be N, the inventory of a third item ID3 can be K, the inventory of a fourth item ID4 can be L, and the inventory of a fifth item ID5 can be P (wherein each of M, N, K, L, and P can be a predetermined natural number).

At time point T1, a first item ID1 is stocked in at location a. A first worker W1 inputs the fact that the first item ID1 has been stocked in via a user terminal 200 assigned to location a. The user terminal 200 transmits information about the first item ID1 stocked in at time point T1 to the apparatus 100. The apparatus 100 can generate a piece of information corresponding to an event, based on the information about the first item ID1. The apparatus 100 can generate a piece of information corresponding to an event that includes information about a time at which the first item ID1 was stocked in at location a (Time), information used to identify the first item ID1 (Item ID), information used to identify the location (Location a), information indicating a change in inventory of items associated with the location (Status), and information about workers (Worker).

At time point T2, a second item ID2 is stocked in at location a. The first worker W1 inputs the fact that the second item ID2 has been stocked in, via the user terminal 200 assigned to location a. The user terminal 200 transmits information about the second item ID2 stocked in at time point T2 to the apparatus 100. The apparatus 100 can generate a piece of information corresponding to an event, based on the information about the second item ID2. Hereinafter, redundant description will be omitted.

At time point T3, a first item ID1 is stocked out from location a. The first worker W1 inputs the fact that the first item ID1 has been stocked out from location a, via the user terminal 200 assigned to location a. The user terminal 200 transmits information about the first item ID1 stocked out at time point T3 to the apparatus 100. The apparatus 100 can generate a piece of information corresponding to an event, based on the information about the first item ID1. In some implementations, when a predetermined sequence number is 3, the apparatus 100 can assign third stored piece of information corresponding to an event, i.e., the piece of information corresponding to an event stored at time point T3, as first snapshot information. The apparatus 100 can assign information (Snapshot) for identifying the piece of information corresponding to an event stored at time point T3 and assigned as the first snapshot information. For example, the apparatus 100 can set the information (bit) for identifying the first snapshot information stored at time point T3 to “1”. However, this is just an example, and the apparatus 100 can assign identification information based on various methods. The apparatus 100 can calculate the inventory of each of at least one item associated with location a at the time of generating the first snapshot information. Before time point T1, the inventory of the first item ID1 associated with location a is N, the inventory of the second item ID2 is N, the inventory of the third item ID3 is K, the inventory of the fourth item ID4 is L, and the inventory of the fifth item ID5 is P. The first item ID1 was stocked in at location a at time point T1, the second item ID2 was stocked in at location a at time point T2, and the first item ID1 was stocked out from location a at time point T3. Therefore, at time point T3, the inventory of the first item ID1 can be (N+1−1), the inventory of the second item ID2 can be (N+1), the inventory of the third item ID3 can be K, the inventory of the fourth item ID4 can be L, and the inventory of the fifth item ID5 can be P. The apparatus 100 can generate the first snapshot information including information 3a indicating the inventory of each of at least one item associated with location a at time point T3. The first snapshot information generated at time point T3 can include the piece of information corresponding to an event generated at time point T3, information about time point T3 at which the snapshot information is generated, and information indicating the inventory of each of the at least one item associated with location a at time point T3.

At time point T4, a first item ID1 is stocked in at location a. The first worker W1 inputs the fact that the first item ID1 has been stocked in, via the user terminal 200 assigned to the location a. The user terminal 200 transmits information about the first item ID1 stocked in at time point T4 to the apparatus 100. The apparatus 100 can generate a piece of information corresponding to an event, based on the information about the first item ID1.

At time point T5, a fifth item ID5 is stocked in at location a. A second worker W2 inputs the fact that the fifth item ID5 has been stocked in, via the user terminal 200 assigned to location a. The user terminal 200 transmits information about the first item ID5 stocked in at time point T5 to the apparatus 100. The apparatus 100 can generate a piece of information corresponding to an event, based on the information about the fifth item ID5. For instance, when the predetermined sequence number is 5, the apparatus 100 can assign fifth stored piece of information corresponding to an event, i.e., the piece of information corresponding to an event stored at time point T5, as second snapshot information. The apparatus 100 can assign information used to identify the piece of information corresponding to an event stored at time point T5 and assigned as the second snapshot information.

The apparatus 100 can calculate the inventory of each of at least one item associated with location a at the time of generating the second snapshot information. The apparatus 100 can calculate the inventory of each of the at least one item based on the first snapshot information, and can calculate the inventory of each of the at least one item associated with location a, based on at least one piece of information corresponding to an event stored after the first snapshot information is generated. In some implementations, in relation to the inventory of each of the at least one item associated with location a stored in the first snapshot information, the inventory of a first item ID1 is M, the inventory of a second item ID2 is (N+1), the inventory of a third item ID3 is K, the inventory of a fourth item ID4 is L, and the inventory of a fifth item ID5 is P. The first item ID1 was stocked in at location a at time point T4 and the fifth item ID5 was stocked in at location a at time point T5. Thus, at time point T5, the inventory of the first item ID1 can be (M+1), the inventory of the second item ID2 can be (N+1), the inventory of the third item ID3 can be K, the inventory of the fourth item ID4 can be L, and the inventory of the fifth item ID5 can be (P+1). The apparatus 100 can generate the second snapshot information including information 5a indicating the inventory of each of at least one item associated with location a at time point T5. The second snapshot information generated at time point T5 can include information about the piece of information corresponding to an event generated at time point T5, information about time point T5 at which the second snapshot information is generated, and the information 5a indicating the inventory of each of the at least one item associated with location a at time point T5.

At time point T6, a fourth item ID4 is stocked in at location a. The second worker W2 inputs the fact that the fourth item ID4 has been stocked in, via the user terminal 200 assigned to the location a. The user terminal 200 transmits information about the fourth item ID4 stocked in at time point T6 to the apparatus 100. The apparatus 100 can generate a piece of information corresponding to an event, based on the information about the fourth item ID4.

At time point T7, a first item ID1 is moved from location a to another location. The second worker W2 inputs the fact that the first item ID1 has been moved, via the user terminal 200 assigned to location a. The user terminal 200 transmits information about the first item ID1 moved at time point T7 to the apparatus 100. The apparatus 100 can generate a piece of information corresponding to an event, based on the information about the first item ID1. For example, when the predetermined sequence number is 7, the apparatus 100 can assign seventh stored piece of information corresponding to an event, i.e., the piece of information corresponding to an event stored at time point T7, as third snapshot information. The apparatus 100 can assign information used to identify the piece of information corresponding to an event stored at time point T7 and assigned as the third snapshot information. The apparatus 100 can calculate the inventory of each of at least one item associated with location a at the time of generating the third snapshot information. The apparatus 100 can calculate the inventory of each of at least one item based on either the first snapshot information or the second snapshot information, and can calculate the inventory of each of the at least one item associated with location a, based on at least one piece of information corresponding to an event stored after the first snapshot information or the second snapshot information is generated. In some implementations, in relation to the inventory of each of the at least one item associated with location a stored in the second snapshot information, the inventory of the first item ID1 is (M+1), the inventory of the second item ID2 is (N+1), the inventory of the third item ID3 is K, the inventory of the fourth item ID4 is L, and the inventory of the fifth item ID5 is (P+1). At time point T6, the fourth item ID4 was stocked out from location a, and at time point T7, the first item ID1 was moved from location a to another location. Thus, at time point T7, the inventory of the first item ID1 can be (M+1−1), the inventory of the second item ID2 can be (N+1), the inventory of the third item ID3 can be K, the inventory of the fourth item ID4 can be (L−1), and the inventory of the fifth item ID5 can be (P+1). The apparatus 100 can generate the third snapshot information including information 7a indicating the inventory of each of at least one item associated with location a at time point T7. The third snapshot information generated at time point T7 can include the piece of information corresponding to an event generated at time point T7, information about time point T7 at which the third snapshot information is generated, and the information 7a indicating the inventory of each of the at least one item associated with location a at time point T7.

At time point T8, a first item ID1 is stocked in at location a. A third worker W3 inputs the fact that the first item ID1 has been stocked in, via the user terminal 200 assigned to location a. The user terminal 200 transmits information about the first item ID1 stocked in at time point T8 to the apparatus 100. The apparatus 100 can generate a piece of information corresponding to an event, based on the information about the first item ID1.

At time point T9, a first item ID1 is stocked out from location a. A fourth worker W4 inputs the fact that the first item ID1 has been stocked out, via the user terminal 200 assigned to location a. The user terminal 200 transmits information about the first item ID1 stocked out at time point T9 to the apparatus 100. The apparatus 100 can generate a piece of information corresponding to an event, based on the information about the first item ID1.

The event information can include at least one piece of information each corresponding to an event. In some implementations, the event information can include pieces of information each corresponding to an event stored at each of times T1 to T9. In some implementations, each piece of the information corresponding to an event can further include information about a worker. The apparatus 100 can further store the worker information that recorded an event occurring on an item associated with a location to identify, e.g., a person who recorded the event occurrence.

FIG. 7 illustrates an example of a process for producing inventory information of a target item. The apparatus 100 can generate inventory information in response to a request for return of inventory information obtained from the user terminal 200. The apparatus 100 can transmit the generated inventory information to the user terminal 200.

The user terminal 200 can transmit, to the apparatus 100, a request for return of inventory information including information indicating a target item at a first time point. In some examples, the first time point can be any time point after time point T9. In response to the request for return of inventory information, the apparatus 100 can generate inventory information of the target item. In some implementations, the apparatus 100 can generate inventory information of the target item indicating a quantity of inventory of the target item and transmit the generated inventory information to the user terminal 200. The inventory information can be displayed on the user terminal 200, and can be used to display the quantity of inventory of the target item.

The apparatus 100 can generate the inventory information based on the event information illustrated in FIG. 5. In some implementations, the apparatus 100 can identify pieces of information each corresponding to an event, which includes information indicating the target item, among pieces of information each corresponding to an event included in event information stored before the first time point. For example, when the user terminal 200 transmits, to the apparatus 100, a request for return of inventory information of the first item ID1 at the first time point, the apparatus 100 can identify pieces of information each corresponding to an event, which includes information indicating the first item ID1, among the pieces of information each corresponding to an event. In this a case, the apparatus 100 can identify pieces of information each corresponding to an event stored at time points T1, T3, T4, T7, T8, and T9.

The apparatus 100 can identify snapshot information that includes the information indicating the target item. In some implementations, snapshot information including information indicating the first item ID1 as the target item is stored at each of time point T3 and time point T7, so the apparatus 100 can identify the first snapshot information stored at time point T3 and the third snapshot information stored at time point T7.

The apparatus 100 can identify snapshot information to which identification information is assigned at a second time point closest to the first time point as target snapshot information. Since the first time point is any time point after time point T9, the second time point that is closest to the first time point among time points T3 and T7 at which the snapshot information was stored is time point T7. The apparatus 100 can identify the third snapshot information stored at T7 as target snapshot information.

The apparatus 100 can generate inventory information of the target item based on the third snapshot information stored at the second time point and pieces of information each corresponding to an event between the second time point and the first time point. In some implementations, the apparatus 100 can generate inventory information of the first item ID1 based on the third snapshot information stored at time point T7, which is the second time point, and pieces of information each corresponding to an event stored at time points T8 and T9. As described above with reference to FIG. 5, the snapshot information stored at time point T7 includes information indicating the inventory of the first item ID1. Based on the snapshot information at time point T7, the apparatus 100 identifies that the inventory of the first item ID1 is M, and because the first item ID1 was stocked in at location a at time point T8 and the first item ID1 was stocked out from location a at time point T9, the apparatus 100 can generate inventory information that includes information indicating that the inventory of the first item ID1 at time point T9 is M. In this way, the apparatus 100 can generate inventory information of the target item based on snapshot information at an adjacent time point and pieces of information each corresponding to an event after the snapshot information at the adjacent time point was stored. Thus, the inventory information of the target item can be easily and accurately generated based on event information that has a large size.

The apparatus 100 can transmit the generated inventory information to the user terminal 200. In some implementations, the inventory information can be displayed on the user terminal 200 and used to indicate that the inventory of the first item ID1 is M at the first point in time.

FIG. 8 illustrates an example of a process for producing inventory information of a target state. The apparatus 100 can generate inventory information in response to a request for return of inventory information obtained from the user terminal 200. The apparatus 100 can transmit the generated inventory information to the user terminal 200.

The user terminal 200 can transmit, to the apparatus 100, a request for the return of inventory information that includes information indicating a target state at a first time point. In some examples, the first time point can be any time point after time point T9. In response to the request for return of inventory information, the apparatus 100 can generate inventory information of the target state. In some implementations, the apparatus 100 can identify pieces of information each corresponding to an event of an item that corresponds to the target state at location a. For example, when the target state is an in-stock state at location a, the apparatus 100 can identify pieces of information each corresponding to an event that includes information indicating the in-stock state (St in), among the pieces of information each corresponding to an event illustrated in FIG. 5. In this case, the apparatus 100 can identify pieces of information each corresponding to an event stored at time points T1, T2, T4, T5, and T8.

The apparatus 100 can generate inventory information based on the pieces of information each corresponding to an event that includes the information indicating the target state. In some implementations, the inventory information can be a result of projection of the pieces of information each corresponding to an event that includes the information indicating the target state. The projection can be an operation that extracts pieces of information each corresponding to an event that include information from the event information and lists the pieces of information each corresponding to an event. The apparatus 100 can identify, extract, and list pieces of information each corresponding to an event that includes information indicating the target state, among the pieces of information each corresponding to an event, and transmit the listed pieces of information each corresponding to an event to the user terminal 200. Thus, the user terminal 200 can identify an item that was stocked in at a specific time point, or can identify an item that was stocked out at a specific time point. In some examples, when the user terminal 200 transmits, to the apparatus 100, a return request that includes information about a target time interval, the apparatus 100 can project pieces of information each corresponding to an event at all time points included in the target time interval and transmit the projected pieces of information each corresponding to an event to the user terminal 200.

Various implementations of the present disclosure can be implemented as software recorded in a machine-readable storage medium. The software can be software for implementing the various implementations of the present disclosure. The software can be inferred from various implementations of the present disclosure by programmers in a technical field to which the present disclosure belongs. For example, the software can be a computer program including machine-readable instructions (e.g., code or a code segment). A machine can be an apparatus capable of operating based on an instruction called from the storage medium, and can be, for example, a computer. In some implementations, the machine can be the apparatus 100 (see FIG. 2) according to the various implementations of the present disclosure. In some implementations, a processor of the machine can execute a called instruction to cause components of the machine to perform a function corresponding to the instruction. In some implementations, the processor can be the processor 110 (see FIG. 2) according to the various implementations of the present disclosure. The storage medium can refer to any type of recording medium which stores machine-readable data. The storage medium can include, for example, a ROM, a RAM, a CD-ROM, a magnetic tape, a floppy disk, an optical data storage apparatus, or the like. In some implementations, the storage medium can be the memory 120 (see FIG. 2). In some implementations, the storage medium can be distributed to computer systems connected over a network. In this case, software can be distributed, stored, and executed in the computer systems. In another implementation, the storage medium can be a non-transitory storage medium. The non-transitory storage medium refers to a tangible medium that exists irrespective of whether information is stored semi-permanently or temporarily, and does not include a transitorily propagated signal.

Although the technical idea of the present disclosure has been described using various implementations, the technical idea of the present disclosure includes various substitutions, modifications, and changes which can be made within the scope of the present disclosure that can be understood by those skilled in the art to which the present disclosure belongs. Furthermore, it should be understood that such substitutions, modifications, and changes can fall within the scope of the accompanying claims.

What is claimed is:

1. An apparatus comprising:
at least one processor; and
at least one memory storing instructions that, based on being executed by the at least one processor, perform operations comprising:
receiving, from a user terminal, a request for inventory information of at least one item stored at a location at a first time point,
in response to receiving the request for the inventory information, obtaining event information including pieces of information each corresponding to an event that caused a change in inventory of items associated with the location before the first time point,
generating the inventory information of the at least one item stored at the location at the first time point based on the event information, and
transmitting the inventory information to the user terminal.

2. The apparatus of claim 1, wherein the operations further comprise:
generating and storing each piece of information corresponding to the event based on the change occurring in the inventory of the items associated with the location.

3. The apparatus of claim 1, wherein each piece of information corresponding to the event includes at least one of (i) information indicating the change in the inventory of the items associated with the location, (ii) information used to identify the items associated with the location, or (iii) information used to identify the location.

4. The apparatus of claim 1, wherein the operations further comprise:
assigning, as snapshot information, a piece of information corresponding to an event that is stored at a predetermined sequence number among the pieces of information, and
wherein the snapshot information includes identification information used to identify the piece of information corresponding to the event that is stored at the predetermined sequence number.

5. The apparatus of claim 4, wherein the snapshot information further includes information indicating inventory of each of the at least one item associated with the location at a time of generating the snapshot information.

6. The apparatus of claim 4, wherein the operations further comprise determining the predetermined sequence number based on a number of the pieces of information.

7. The apparatus of claim 4, wherein the operations further comprise storing the snapshot information in a storage space that is different from a storage space for pieces of information each corresponding to an event to which the identification information is not assigned.

8. The apparatus of claim 4, wherein the operations further comprise:
identifying target snapshot information among the snapshot information in response to the request for the inventory information; and
generating the inventory information based on the target snapshot information and pieces of information each corresponding to an event stored after the target snapshot information was stored.

9. The apparatus of claim 8, wherein the request for the inventory information includes information indicating a target item among the at least one item, and
wherein the operations further comprise:
identifying pieces of snapshot information including the information indicating the target item among the snapshot information;
identifying, as the target snapshot information, one of the pieces of snapshot information to which the identification information is assigned at a second time point closest to the first time point, among the pieces of snapshot information including the information indicating the target item; and
generating the inventory information based on (i) the target snapshot information and (ii) a piece of information that includes the information indicating the target item among a subset of the event information that is stored between the second time point and the first time point.

10. The apparatus of claim 1, wherein the request for the inventory information includes information indicating a target state among states of the at least one item, and
wherein the operations further comprise:
identifying a piece of information that includes the information indicating the target state among the pieces of information included in the event information; and
generating the inventory information based on the piece of information including the information indicating the target state.

11. A method comprising:
receiving, from a user terminal, a request for inventory information of at least one item stored at a location at a first time point;
in response to receiving the request for the inventory information, obtaining event information including pieces of information each corresponding to an event that caused a change in inventory of items associated with the location before the first time point;
generating the inventory information of the at least one item stored at the location at the first time point based on the event information; and
transmitting the inventory information to the user terminal.

12. The method of claim 11, further comprising:
generating and storing each piece of information corresponding to the event based on the change occurring in the inventory of the items associated with the location.

13. The method of claim 11, wherein each piece of information corresponding to the event includes at least one of (i) information indicating the change in the inventory of items associated with the location, (ii) information used to identify the items associated with the location, or (iii) information used to identify the location.

14. The method of claim 11, further comprising:
assigning, as snapshot information, a piece of information corresponding to an event that is stored at a predetermined sequence number among the pieces of information, and wherein the snapshot information includes identification information used to identify the piece of information corresponding to the event that is stored at the predetermined sequence number.

15. The method of claim 14, further comprising:
determining the predetermined sequence number based on a number of the pieces of information.

16. The method of claim 14, wherein generating the inventory information of the at least one item stored at the location at the first time point comprises:
identifying target snapshot information among the snapshot information in response to the request for the inventory information; and
generating the inventory information based on the target snapshot information and pieces of information each corresponding to an event that are stored after the target snapshot information was stored.

17. The method of claim 16, wherein the request for the inventory information includes information indicating a target item among the at least one item,
wherein identifying the target snapshot information among the snapshot information comprises:
identifying pieces of snapshot information including the information indicating the target item among the snapshot information; and
identifying, as the target snapshot information, one of the pieces of snapshot information to which the identification information is assigned at a second time point closest to the first time point, among the pieces of snapshot information including the information indicating the target item, and
wherein generating the inventory information based on the target snapshot information and the pieces of information that are stored after the target snapshot information was stored further comprises:
obtaining first inventory information of the target item at the second time point,
identifying, based on the pieces of information that are stored between the second time point and the first time point, at least one piece of information each corresponding to an event of the target item, and
generating the inventory information based on the first inventory information and the at least one piece of information corresponding to the event of the target item.

18. A non-transitory computer-readable recording medium storing instructions, wherein execution of the instructions causes at least one processor to perform operations comprising:
receiving, from a user terminal, a request for inventory information of at least one item stored at a location at a first time point;
in response to receiving the request for the inventory information, obtaining event information including pieces of information each corresponding to an event that caused a change in inventory of items associated with the location before the first time point;
generating the inventory information of the at least one item stored at the location at the first time point based on the event information; and
transmitting the inventory information to the user terminal.
